(19) United States
(12) Patent Application Publication
(10) Pub. No.: US 2009/0093933 A1
(43) Pub. Date: Apr. 9, 2009

(54) Integrated control system for vehicles

(75) Inventors: Jong Dae Kim, Gwanak-Gu (KR); Kwi Han Chae, Ansan-Si (KR); Sang Kil Lee, Hwaseong-Si (KR); Jae Kwan Lee, Yongin-Si (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/287,444

(22) Filed: Oct. 8, 2008

(30) Foreign Application Priority Data
Oct. 8, 2007 (KR) 10-2007-0100952

(51) Int. Cl. G06F 19/00

(52) U.S. Cl. 701/46

(57) ABSTRACT

The present invention relates to an integrated safety control system for vehicles. In particular, the present invention includes a sensor unit, an actuating unit, an actuating control unit, and an integrated control unit. The sensor unit includes a plurality of sensors for outputting sensed signals required for chassis control and Advanced Safety Vehicle (ASV) control of the vehicle. The actuating unit includes a plurality of actuating subunits for performing the chassis control and the ASV control. The actuating control unit includes a plurality of actuating control subunits provided for the respective actuating subunits, and configured to operate the respective actuating subunits. The integrated control unit compares and analyzes the sensed signals and selectively controls the respective actuating subunits so as to perform chassis control and ASV control in an integrated control manner.

### CROSS-REFERENCE TO RELATED APPLICATIONS

This application claims priority to Korean Application No. 10-2007-0100952, filed on Oct. 8, 2007, the entire disclosure of which is incorporated herein by reference.

### BACKGROUND

1. Technical Field

The present invention relates to an integrated safety control system for vehicles.

2. Background Art

Generally, vehicles are equipped with various types of electronic control systems to such an extent that each vehicle is considered to be an electronic system.

An Electronic Control Unit (ECU) used in a vehicle receives sensed signals from various types of sensors, detects the status of the vehicle, and operates various types of actuating units. The types of ECU are classified into Electronic Power Steering (EPS) ECU, an Anti-Lock Braking System (ABS) ECU, a Continuous Damper Control (CDC) ECU, etc. Such an ECU controls the suspension, braking, steering, and driving of a vehicle, thus improving the safety and riding comfort of a vehicle.

Further, Electronic Control Suspension (ECS) enables grip force and driving force against a road surface to be secured, as the strength of suspension and the height of a vehicle are controlled depending on road conditions and vehicle speed, and enables traveling safety and riding comfort to be improved according to speed sensitivity. An Advanced Safety Vehicle (ASV) is designed to improve the safety of vehicles on the basis of technologies such as a doze warning system, a night obstacle sensing system, and a danger warning system, thus preventing vehicle accidents.

However, since respective individual systems employ their own independent CPUs, input interface units, and output interface units, there is a problem in that costs attributable to the use of individual systems are significantly high.

The information disclosed in this Background section is only for enhancement of understanding of the background of the invention and should not be taken as an acknowledgement or any form of suggestion that this information forms the prior art that is already known to a person skilled in the art.

### SUMMARY

Accordingly, the present invention has been made keeping in mind the above problems occurring in the prior art, and an object of the present invention is to provide an integrated safety control system for vehicles, which can control the chassis control part and the ASV control part of a vehicle in an integrated control manner, thus improving control efficiency and decreasing costs.

The integrated safety control system according to the present invention may comprise a sensor unit, an actuating unit, an actuating control unit, and an integrated control unit. The sensor unit includes a plurality of sensors each of which senses signals required for chassis control and ASV control of a vehicle. The actuating unit includes a plurality of actuating subunits for performing chassis control and ASV control. The actuating control unit includes a plurality of actuating control subunits provided for the respective actuating subunits and configured to operate the respective actuating subunits. The integrated control unit compares and analyzes the sensed signals and selectively controls respective actuating subunits based on the analysis so as to perform an integrated chassis and ASV control.

Preferably, each of the actuating control subunits may be realized as a microcomputer that can operate only the corresponding actuating subunit. The chassis control system may comprise at least one unit selected from the group consisting of a braking control unit, a steering control unit, a suspension control unit, and a driving control unit. The ASV control system may comprise at least one unit selected from the group consisting of an auto-driving control unit, a driver state monitoring control unit, a lighting control unit, a night obstacle sensing control unit, and a danger warning control unit.

Each of the actuating subunits may include at least one actuator, at least one drive motor, or both.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a diagram showing the construction of an integrated safety control system for vehicles according to the present invention; and

FIG. 2 is a reference diagram showing an integrated safety control system for vehicles according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

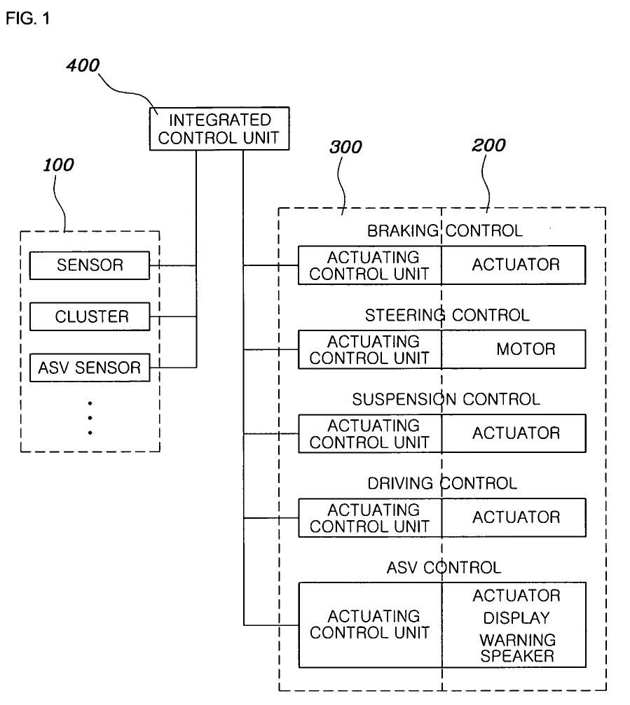

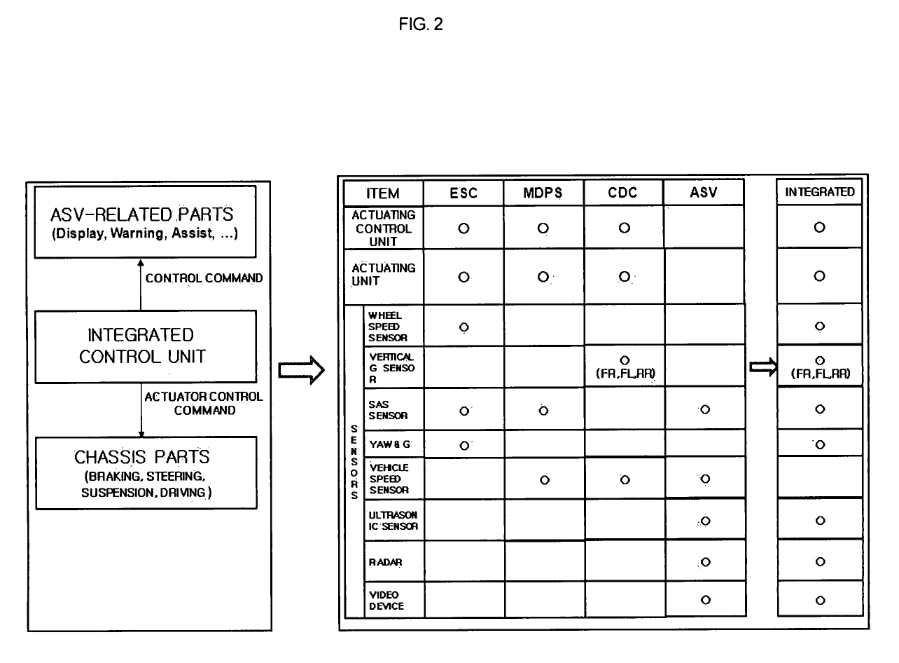

As shown in FIGS. 1 and 2, the present invention provides an integrated safety control system for controlling an Advanced Safety Vehicle (ASV) system with a chassis control system in an integrated control manner.

The integrated safety control system according to the present invention may be embodied in an existing Intelligent Vehicle Safety System (IVSS), so that control logic can be easily developed, and actual vehicle tuning and development can be facilitated, thus preventing problems of low vehicle quality from occurring.

The integrated safety control system of the present invention may include a sensor unit 100 configured to output sensed signals, an actuating unit 200 used for chassis control and ASV control, an actuating control unit 300 provided for the actuating unit 200, and an integrated control unit 400 for performing the chassis and ASV control in an integrated control manner.

The sensor unit 100 may comprise one or more sensors which sense respective signals required for the chassis control and ASV control and output the sensed signals. In the present integrated safety control system, the sensors used for the chassis control system and the sensors used for the ASV system are in common.

The actuating unit 200 may include one or more actuating subunits (e.g., a braking control unit, a steering control unit, a suspension control unit, a driving control unit as shown in FIG. 1). Each of the subunits may include at least one actuators, at least one drive motor or both.

Each of the subunits may be provided with respective actuating control subunits. Each of the actuating control subunits may be implemented using a microcomputer that can function to operate only the corresponding actuating subunit.

As described above, since the function of the respective ECU microcomputers used in the respective chassis control systems are limited only to operate the respective actuating subunits, the costs for ECU microcomputers can be remarkably decreased.

Meanwhile, the sensor unit 100 and the actuating control unit 300 are controlled by the integrated control unit 400. The integrated control unit 400 is configured to additionally control the ASV system while integrating the ECU microcomputers applied to respective chassis control units into a single integrated control unit 400.

The integrated control unit 400 receives the sensed signals from the sensor unit 100, and compares and analyzes the sensed signals, thereby selectively controlling the actuating control subunits. The integrated control unit 400 appropriately operates individual actuating subunits in a manner that ensures the safety of the vehicle, thereby improving traveling safety and riding comfort.

For this operation, the integrated control unit 400 performs chassis control (e.g., braking control, steering control, suspension control and driving control) and ASV control (e.g., auto-driving control, driver state monitoring control, lighting control, night obstacle sensing control, and danger warning control) in an integrated control manner.

The integrated safety control system may have different components and functions depending on the classes and costs of vehicles. For example, in the case of a luxury vehicle, steering control, braking control, suspension control, driving control, and ASV control can be performed by the integrated safety control system. On the other hand, in the case of a medium-size or economy vehicle, only steering control, braking control, and ASV control can be performed by the integrated safety control system.

As described above, according to the present integrated safety control systems for vehicles, control efficiency can be improved, and development costs can be reduced. Further, suitable vehicles satisfying customers' needs can be promptly developed on the basis of control logic implemented as a module, and ASV functions can be easily applied to vehicles, thus gaining an advantage in the development of intelligent vehicles.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An integrated safety control system for a vehicle, comprising:
a sensor unit which includes a plurality of sensors for outputting sensed signals required for chassis control and Advanced Safety Vehicle (ASV) control of the vehicle;
an actuating unit which includes a plurality of actuating subunits for performing the chassis control and the ASV control;
an actuating control unit which includes a plurality of actuating control subunits provided for the respective actuating subunits, and configured to operate the respective actuating subunits; and
an integrated control unit for comparing and analyzing the sensed signals and selectively controlling the respective actuating subunits on the basis of the analysis so as to perform chassis control and ASV control in an integrated control manner.

2. The integrated safety control system according to claim 1, wherein each of the actuating control subunits is a microcomputer that can operate only the corresponding actuating control subunit.

3. The integrated safety control system according to claim 1, wherein the chassis control comprises at least one unit selected from the group consisting of a braking control unit, a steering control unit, a suspension control unit, and a driving control unit.

4. The integrated safety control system according to claim 1, wherein the ASV control comprises at least one unit selected from the group consisting of an auto-driving control unit, a driver state monitoring control unit, a lighting control unit, a night obstacle sensing control unit, and a danger warning control unit.

5. The integrated safety control system according to claim 1, wherein each of the actuating subunits comprises at least one actuator, at least one motor or both.
